(19) United States
(12) Patent Application Publication
(10) Pub. No.: US 2025/0033695 A1
(43) Pub. Date: Jan. 30, 2025

(54) METHOD FOR DETERMINING A STEERING WHEEL OVERLAY TORQUE FOR TRANSMISSION TO A STEERING WHEEL OF A STEER-BY-WIRE STEERING SYSTEM

(71) Applicant: Ford Global Technologies, LLC, Dearborn, MI (US)

(72) Inventors: Fabian Roeckner, Köln (DE); Jan Bremkens, Straelen (DE)

(21) Appl. No.: 18/773,147

(22) Filed: Jul. 15, 2024

(30) Foreign Application Priority Data
Jul. 28, 2023 (DE) 10 2023 120 191.3

(51) Int. Cl. B62D 6/00; B62D 5/00; G01L 5/22

(52) U.S. Cl. CPC B62D 6/008; B62D 5/006; G01L 5/221

(57) ABSTRACT

A method for determining a steering wheel overlay torque for transmission to a steering wheel of a steer-by-wire steering system is disclosed. An example steer-by-wire steering system includes a steering wheel actuator operatively coupled to a steering wheel, a road wheel actuator operatively coupled to steerable wheels of the vehicle, and programmable circuitry to communicate with the steering and road wheel actuators, the programmable circuitry to at least one of instantiate or execute machine readable instructions to identify an overlay force to be applied by the road wheel actuator, the overlay force from a driver assistance function, identify a torque encountered by the steering wheel, determine a steering wheel torque that corresponds with the overlay force and the torque encountered by the steering wheel, and determine an overlay torque for the steering wheel actuator based on the steering wheel torque and the torque encountered by the steering wheel.

### RELATED APPLICATION

This patent claims priority to German Patent Application No. 10 2023 120 191.3, which was filed on Jul. 28, 2023. German Patent Application No. 10 2023 120 191.3 is hereby incorporated herein by reference in its entirety. Priority to German Patent Application No. 10 2023 120 191.3 is hereby claimed.

### FIELD OF THE DISCLOSURE

This disclosure relates generally to vehicle steering systems and, more particularly, to a method for determining a steering wheel overlay torque for transmission to a steering wheel of a steer-by-wire steering system.

### BACKGROUND

Vehicles, in particular motor vehicles, are normally equipped with driver assistance functions. Some driver assistance functions, for example a lane assist system, have been developed, using modern technology, in a way that requires a specific lateral reaction by the vehicle by requesting an overlay torque from an electronic power steering system. To control this lateral reaction of the vehicle with a continuous, linear control approach, the force transmitted to the wheels by a gear rack must behave in proportion to the requested overlay torque. This is accomplished in the case of conventional electronic assisted steering systems by means of a mechanical connection between an assisted steering actuator and the steered wheels. The request from the driver assistance function can be actioned by means of either an overlay torque and/or an overlay force.

### BRIEF DESCRIPTION OF THE DRAWINGS

FIG. 1 schematically shows a steer-by-wire steering system of a vehicle.

FIG. 2 schematically shows an inventive control method for a steer-by-wire steering system in the form of a flowchart representative of example machine readable instructions and/or example operations that may be executed, instantiated, and/or performed by example programmable circuitry of the steer-by-wire steering system of FIG. 1.

FIG. 3 schematically shows the signal transmission and processing during a control method according to the examples disclosed herein.

FIG. 4 schematically shows a vehicle according to implement examples disclosed herein.

FIG. 5 is a block diagram of an example processing platform including programmable circuitry structured to execute, instantiate, and/or perform the example machine readable instructions and/or perform the example operations of FIG. 2 to implement the programmable circuitry of FIG. 1.

In general, the same reference numbers will be used throughout the drawing(s) and accompanying written description to refer to the same or like parts. The figures are not necessarily to scale.

### DETAILED DESCRIPTION

In some steer-by-wire steering systems, the mechanical connection between the steering wheel and the wheels no longer exists. In these systems, the wheel actuator complies with a stipulated angle specification that is determined by a driver input, for example by means of a steering wheel in conjunction with a steering wheel actuator. At the same time, feedback pertaining to the current driving situation is provided in the form of a feedback counter torque applied to the steering wheel. This feedback counter torque is normally based on a conversion function or conversion table in which input values are representative of the present steering force on the gear rack or of the present torque in proportion to the force transmitted to the wheels by means of the gear rack.

To be able to continue to implement the driver assistance functions described above, examples disclosed herein convert an overlay force or overlay torque, which is proportional to the steering force that is transmitted to the wheels, of a conventional steering system into an overlay torque on a steering wheel in a steer-by-wire system. Application of this overlay torque to the steering wheel by means of the steering wheel actuator produces a steering wheel movement that results in an equilibrium between the overlay torque, a possible torque applied by a driver, and the feedback counter torque. In examples disclosed herein, the feedback counter torque is based on the force that acts on the gear rack, which is brought about by the tire displacement produced by means of the wheel actuator as a result of the steering request input via the steering wheel actuator. Advantageously, the balance between the overlay torque, the possible torque applied by a driver, and the feedback counter torque enables the vehicle reactions to have the same characteristics as in a conventional, mechanically coupled steering system.

Examples disclosed herein provide an advantageous method for determining a steering wheel overlay torque for transmission to a steering wheel of a steer-by-wire steering system of a vehicle. Other objects are to provide a control method for a steer-by-wire steering system of a vehicle, a control apparatus for controlling a steering wheel actuator of a steer-by-wire steering system of a vehicle and a vehicle, and also a computer-implemented method, a computer program product, a computer-readable data carrier and a data carrier signal.

An example method for determining (e.g., computing) a steering wheel overlay torque for transmission to a steering wheel of a steer-by-wire steering system of a vehicle disclosed herein includes receiving a request from a driver assistance system (e.g., a driver assistance function for assisted steering) for force or torque overlay for transmission to the wheels that is proportional to a force transmitted to the wheels by means of a gear rack. The example method disclosed herein includes determining (e.g., recording) a torque (e.g., a present steering wheel torque) currently applied to the steering wheel.

The example method disclosed herein includes converting (e.g., arithmetically converting) the recorded present steering wheel torque to a force or torque that is proportional to the force transmitted to the wheels by means of the gear rack. The example method disclosed herein includes ascertaining a requested total force or a requested total torque that is proportional to the force transmitted to the wheels by means of a gear rack. For example, the requested total force can be ascertained by adding the requested force or the requested torque and the force or torque that has been converted (e.g., arithmetically converted) from the determined present steering wheel torque to the force that is proportional to the force transmitted to the wheels via the gear rack.

The example method disclosed herein includes ascertaining (e.g., computing) a total steering wheel torque based on the ascertained requested total force or the ascertained requested total torque. The example method disclosed herein includes ascertaining (e.g., computing) the steering wheel overlay torque based on the determined (e.g., recorded) present steering wheel torque and the determined total steering wheel torque.

Advantageously, the example method disclosed herein can be used to ascertain an overlay torque for a steering wheel of a steer-by-wire steering system that provides a driver with a steering feel that corresponds to that of a conventional, mechanically coupled steering system.

In some examples, the present steering wheel torque is determined by means of a torque sensor and/or by means of software for determining the present steering wheel torque on the basis of known operating state variables of the vehicle. The steering wheel torque applied via the driver can be determined for example on the basis of the currently requested steering wheel actuator torque, the present change in steering wheel angular velocity, and a moment of inertia counteracting the change in steering wheel angular velocity. Additionally, for example the steering wheel angular velocity and a friction torque counteracting the steering wheel angular velocity can also be taken into account as well.

In another example, the recorded present steering wheel torque can be converted into a force or torque applied to steerable wheels (e.g., tires, road wheels) by means of an inverse conversion function (e.g., arithmetic conversion function), or a conversion table (e.g., arithmetic conversion table). The inverse conversion function or the conversion table can be based on a conversion function or a conversion table that is designed to determine (e.g., compute) a feedback counter torque to be applied to the steering wheel based on a force that actuates the steerable wheels in the current driving situation.

The ascertained requested total force or the requested total torque can be converted, for example, by means of a function (e.g. a computation function) or a conversion table that is designed to determine (e.g. compute) a feedback counter torque. The same conversion function or the same conversion table can be used to convert the recorded present steering wheel torque into a force or torque and to convert the ascertained requested total force or the requested total torque. A conversion function and/or a conversion table that is designed to determine a feedback counter torque on the basis of at least one variable that represents the present gear rack steering force or a torque that is proportional to the steering force transmitted to the wheels can be used. This makes it possible to ensure that the application of the computed overlay torque by a steering wheel actuator corresponds to the gear rack force that would arise in a conventional, mechanically coupled steering system if an originally requested torque overlay were applied. Moreover, a balance corresponding to a conventional, mechanically coupled steering system is achieved between the overlay torque, the possible torque applied by a driver and the counter torque that is triggered as a result of the gear rack force produced by the tire deflection produced by means of the wheel actuator according to a steering request.

Preferably, the steering wheel overlay torque is ascertained by subtracting the recorded present steering wheel torque and the ascertained total steering wheel torque. Acquired or ascertained input signals and/or intermediate values and/or output signals can be processed further (e.g., filtered) to cause signal noise to be reduced and/or to cause sudden unwanted step changes in the signal values to be diminished.

In addition to determining a steering wheel overlay torque of a steer-by-wire steering system of a vehicle, as discussed above, a present feedback counter torque on the steering wheel is determined. The present feedback counter torque on the steering wheel can be determined on the basis of a present gear rack torque applied to the wheels of the vehicle, e.g. applied by means of a wheel actuator. The determined present feedback counter torque and/or the steering wheel overlay torque can be adapted if the present feedback counter torque is dependent on at least one variable or one parameter that is not representative of a present gear rack torque applied to the wheels of the vehicle. Said torque can be adapted for example by multiplying it by a constant or by a dynamically computed factor. Advantageously, the dynamically computed factor or the constant is representative of the ratio between components of the counter torque that are dependent on the gear rack force and components of the counter torque that are not dependent on the gear rack force.

The aforementioned steps can be carried out simultaneously or in any order. Subsequently, a steering wheel actuator overlays the present feedback counter torque on the steering wheel and the determined steering wheel overlay torque in an output torque applied to the steering wheel. A steering system in accordance with examples disclosed herein includes the features described above in connection with the method for determining a steering wheel overlay torque.

An example control apparatus for controlling a steering wheel actuator of a steer-by-wire steering system of a vehicle includes a device (e.g., programmable circuitry) for receiving a request from a driver assistance system for a force or torque overlay for transmission to the wheels, a device (e.g., programmable circuitry) for determining a steering wheel overlay torque by means of the method for determining a steering wheel overlay torque as described above, and a device (e.g., programmable circuitry) for determining a present feedback counter torque on the steering wheel. As such, the control apparatus performs the operations described herein to control a steer-by-wire steering system.

An example vehicle in accordance with the examples disclosed herein includes a steer-by-wire steering system and the control apparatus discussed above. As such, the vehicle has the advantages already described. The vehicle may be a motor vehicle or a ship. The motor vehicle may be a passenger vehicle, a truck, a bus, a minibus, a motorcycle or a moped. The vehicle may also be an electric vehicle or a hybrid vehicle (e.g., a Hybrid Electric Vehicle (HEV)).

An example machine readable medium includes instructions that, when executed by a programmable circuitry (e.g., computer), cause the programmable circuitry to carry out operations as described above. The instructions, when executed by the programmable circuitry, cause the programmable circuitry to performs operations to determine a steering wheel overlay torque for transmission to a steering wheel of a steer-by-wire steering system. The instructions are stored on a computer-readable data carrier (e.g., memory).

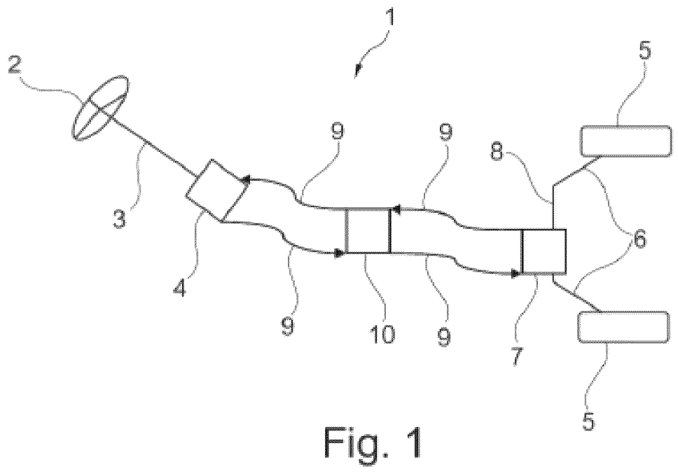

FIG. 1 schematically shows a steer-by-wire steering system 1 of a vehicle. The steering system 1 includes a steering wheel 2, a steering rod 3, and a steering wheel actuator 4, which are mechanically connected (e.g., operatively coupled). The steering system 1 also includes steerable wheels 5, tie rods 6, a gear rack 8, and a wheel actuator 7 (e.g., a road wheel actuator), which are mechanically connected (e.g., operatively coupled). Specifically, the tie rods 6 connect the gear rack 8 to the steerable wheels 5. Additionally, the steering system 1 includes control circuitry 10 that is communicatively connected to the steering wheel actuator 4 and the road wheel actuator 7 for signal transmission purposes. The signal communications are identified by arrows 9. The control circuitry 10 may also be designed to receive other signals.

The steering rod 3 relays a steering input (e.g., a steering request) by a driver via the steering wheel 2 to the steering wheel actuator 4. The steering wheel actuator 4 can also transmit torque to the steering rod 3. The road wheel actuator 7 provides a force or torque to the gear rack 8. The control circuitry 10 can determine (e.g., measure, receive) a force that the road wheel actuator 7 applied to the gear rack 8.

The control circuitry 10 receives signals that include an estimated or measured present steering wheel torque and/or a steering wheel rotation angle from the steering wheel actuator 4. The control circuitry 10 also receives signals representative of the present steering angle, a torque overlay request from a driver assistance function, and/or a force currently applied to the gear rack 8 force from the road wheel actuator 7. The signals transmitted from the control circuitry 10 to the steering wheel actuator 4 represent, for example, a computed total torque demand that is based on the measured or estimated force or the corresponding torque on the gear rack, the measured or estimated steering wheel torque, and the torque overlay request.

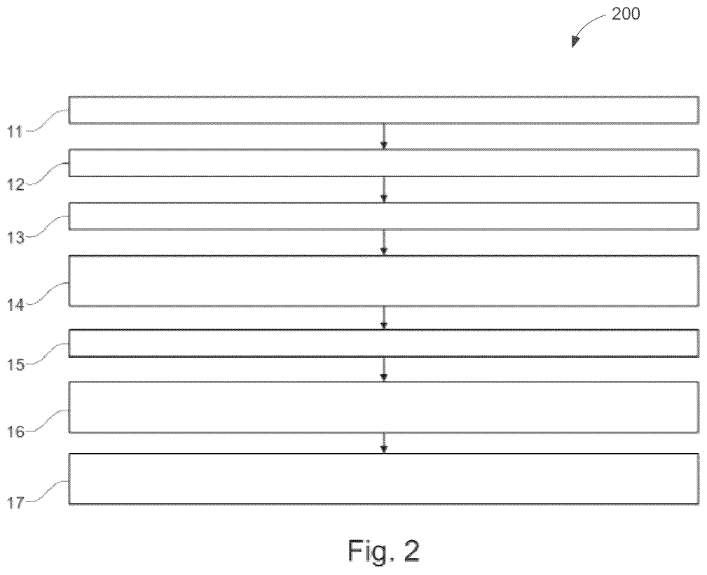

FIG. 2 is a flowchart representative of example machine readable instructions and/or example operations 200 that may be executed, instantiated, and/or performed by programmable circuitry to determine a steering wheel overlay torque in a steer-by-wire system. At block 11, the control circuitry 10 receives a request from a driver assistance system for force or torque overlay for transmission to the wheels that is proportional to a force transmitted to the wheels by means of a gear rack. At block 12, the control circuitry 10 determines a torque (present steering wheel torque) currently applied to the steering wheel.

At block 13, the control circuitry 10 converts (e.g., arithmetically converts) the recorded present steering wheel torque into a force or torque that is proportional to the force transmitted to the wheels via the road wheel actuator 7 and the gear rack 8. At block 14, the control circuitry 10 determines a requested total force or a requested total torque, which is proportional to the force transmitted to the wheels via the road wheel actuator 7 and the gear rack 8, by adding the requested force or the requested torque and the force or torque that has been converted from the determined present steering wheel torque.

At block 15, the control circuitry 10 ascertains a total steering wheel torque based on the ascertained requested total force or the ascertained requested total torque. At block 16, the control circuitry 10 ascertains the steering wheel overlay torque based on the determined present steering wheel torque and the ascertained total steering wheel torque. At block 17, the control circuitry 10 overlays an ascertained present feedback counter torque on the steering wheel 2 with the determined steering wheel overlay torque. The steering wheel actuator 4 can cause the overlayed counter torque and overlay torque to be applied to the steering wheel 2.

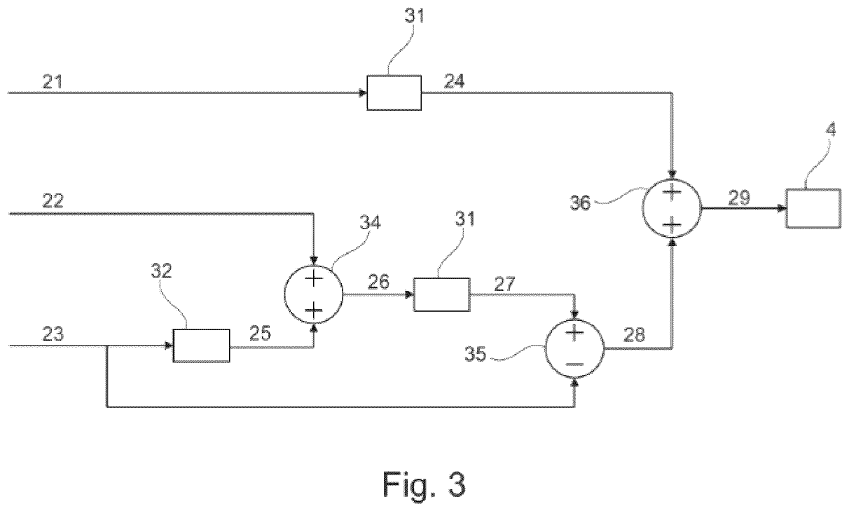

FIG. 3 is a schematic representation of example signal transmission and processing performed by the control circuitry 10. The signal 21 represents the present gear rack force from the road wheel actuator 7. The control circuitry 10 utilizes a conversion function or arithmetic conversion table 31 to convert the signal 21 into a signal 24 that represents a feedback counter torque.

The signal 22 represents the torque overlay request from a driver assistance function, in particular an overlay force to be applied to the gear rack 8 for transmission to the wheels 5. The acquisition of the signal 22 corresponds to block 11 in FIG. 2. The signal 23 represents the torque currently applied to the steering wheel 2.

The signal 23, reception of which corresponds to block 12 described above, is converted into a signal 25 by means of an inverse conversion function or conversion table 32 for computing the gear rack force on the basis of a present steering wheel torque. The signal 25 represents the computed gear rack force. The conversion step corresponds to block 13 in FIG. 2.

The signal 22 is added to the signal 25 by means of an adder 34. This corresponds to block 14 in FIG. 2. The resultant signal 26 is subsequently converted by means of a conversion function or a conversion table 31 into a signal 27 that represents a total torque demand on the steering wheel. The signal 23 is subsequently deducted from the signal 27 by means of an adder 35. This corresponds to block 16 in FIG. 2. The resulting signal 28 represents the steering wheel overlay torque. This is subsequently added to the signal 24 by means of an adder 36. This corresponds to block 17 in FIG. 2. The resulting signal 29, which corresponds to the total torque to be applied to the steering wheel, is applied to the steering wheel 2 by means of the steering wheel actuator 4.

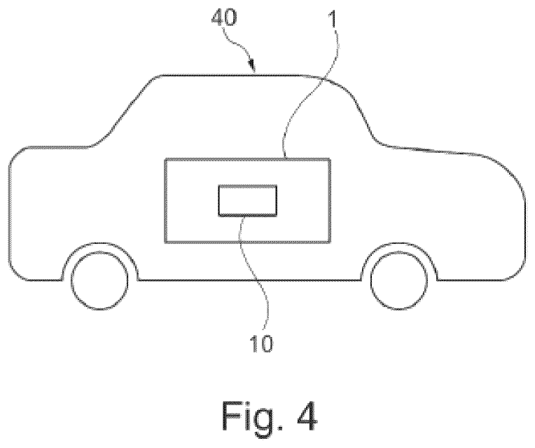

FIG. 4 schematically shows an example vehicle 40 that can be utilized to implement examples disclosed herein. The vehicle 40 includes the steer-by-wire system 1 that has the control circuitry 10 designed to carry out for example a method described with reference to FIGS. 2 and 3.

The control circuitry 10 of FIGS. 1 and 4 may be instantiated (e.g., creating an instance of, bring into being for any length of time, materialize, implement, etc.) by programmable circuitry such as a Central Processor Unit (CPU) executing first instructions. Additionally or alternatively, the control circuitry 10 of FIGS. 1 and 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the control circuitry 10 of FIGS. 1 and 4 may, thus, be instantiated at the same or different times. Some or all of the control circuitry 10 of FIGS. 1 and 4 may be instantiated, for example, in one or more threads executing concurrently on hardware and/or in series on hardware. Moreover, in some examples, some or all of the control circuitry 10 of FIGS. 1 and 4 may be implemented by microprocessor circuitry executing instructions and/or FPGA circuitry performing operations to implement one or more virtual machines and/or containers. In some examples, the control circuitry 10 of FIGS. 1 and 4 is instantiated by programmable circuitry executing control instructions and/or configured to perform operations such as those represented by the flowchart of FIG. 2 and the signal transmission and processing of FIG. 3.

While an example manner of implementing the control circuitry 10 of FIG. 1 is illustrated in FIGS. 1 and 4, one or more of the elements, processes, and/or devices illustrated in FIGS. 1 and 4 may be combined, divided, re-arranged, omitted, eliminated, and/or implemented in any other way. Further, the example control circuitry 10 of FIGS. 1 and 4, may be implemented by hardware alone or by hardware in combination with software and/or firmware. Thus, for example, the example control circuitry 10 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example control circuitry 10 of FIGS. 1 and 4 may include one or more elements, processes, and/or devices in addition to, or instead of, those illustrated in FIGS. 1 and 4, and/or may include more than one of any or all of the illustrated elements, processes and devices.

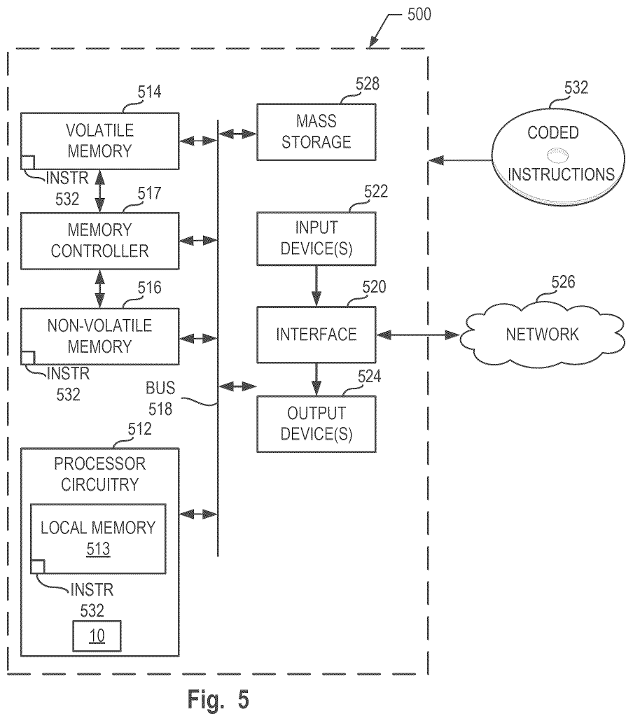

A flowchart representative of example machine readable instructions, which may be executed by programmable circuitry to implement and/or instantiate the control circuitry 10 of FIGS. 1 and 4 and/or representative of example operations which may be performed by programmable circuitry to implement and/or instantiate the control circuitry 10 of FIGS. 1 and 4, is shown in FIG. 2. The machine readable instructions may be one or more executable programs or portion(s) of one or more executable programs for execution by programmable circuitry such as the programmable circuitry 512 shown in the example processor platform 500 discussed below in connection with FIG. 5. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 2, many other methods of implementing the example control circuitry 10 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 2 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a block diagram of an example programmable circuitry platform 500 structured to execute and/or instantiate the example machine-readable instructions and/or the example operations of FIG. 2 to implement the control circuitry 10 of FIGS. 1-4. The programmable circuitry platform 500 can be, for example, a computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, DSPs, and/or microcontrollers from any desired family or manufacturer. The programmable circuitry 512 may be implemented by one or more semiconductor based (e.g., silicon based) devices. In this example, the programmable circuitry 512 implements the control circuitry 10.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, a torque sensor, a position sensor, and/or an electronic signal receiver.

One or more output devices 524 are also connected to the interface circuitry 520 of the illustrated example. The output device(s) 524 can be implemented, for example, by a signal transmitter and/or an actuator. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIG. 2, may be stored in the mass storage device 528, in the volatile memory 514, in the non-volatile memory 516, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one

B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor

Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to determine a steering wheel overlay torque for transmission to a steering wheel of a steer-by-wire steering system are disclosed herein. Further examples and combinations thereof include the following:

Example 1 includes a steer-by-wire steering system for a vehicle, the steer-by-wire steering system comprising a steering wheel actuator operatively coupled to a steering wheel, a road wheel actuator operatively coupled to steerable wheels of the vehicle, and programmable circuitry to communicate with the steering wheel actuator and the road wheel actuator, the programmable circuitry to at least one of instantiate or execute machine readable instructions to identify an overlay force to be applied by the road wheel actuator, the overlay force from a driver assistance function, identify a torque encountered by the steering wheel, determine a steering wheel torque that corresponds with the overlay force and the torque encountered by the steering wheel, and determine an overlay torque for the steering wheel actuator based on the steering wheel torque and the torque encountered by the steering wheel.

Example 2 includes the steer-by-wire steering system of any preceding example, wherein the programmable circuitry is to at least one of instantiate or execute the machine readable instructions to determine a feedback counter torque to be provided to the steering wheel based on a force applied by the road wheel actuator, and determine an output torque for the steering wheel actuator based on the feedback counter torque and the overlay torque.

Example 3 includes the steer-by-wire steering system of any preceding example, wherein the programmable circuitry is to at least one of instantiate or execute the machine readable instructions to convert the torque encountered by the steering wheel to an associated force for the road wheel actuator, combine the overlay force and the associated force to obtain a combined force for the road wheel actuator, convert the combined force to a total torque for the steering wheel, and subtract the torque encountered by the steering wheel from the total torque to obtain the overlay torque.

Example 4 includes the steer-by-wire steering system of any preceding example, wherein the programmable circuitry is to at least one of instantiate or execute the machine readable instructions to determine a feedback counter torque to be combined with the overlay torque based on a force applied by the road wheel actuator, and wherein a same conversion function or table is utilized to convert (i) the force applied by the road wheel actuator to the feedback counter torque and (ii) the combined force to the total torque for the steering wheel.

Example 5 includes the steer-by-wire steering system of any preceding example, wherein the programmable circuitry is to receive a request to cause the road wheel actuator to apply the overlay force.

Example 6 includes the steer-by-wire steering system of any preceding example, wherein the overlay force is proportional to a steering force applied to move the steerable wheels.

Example 7 includes the steer-by-wire steering system of any preceding example, wherein the overlay torque produces a movement of the steering wheel that results in an equilibrium between the overlay torque, the torque encountered by the steering wheel, and a feedback counter torque.

Example 8 includes a method comprising identifying an overlay force to be applied by a road wheel actuator of a vehicle, the overlay force from a driver assistance function, identifying a torque encountered by a steering wheel, determining a steering wheel torque that corresponds with the overlay force and the torque encountered by the steering wheel, and determining an overlay torque for a steering wheel actuator based on the steering wheel torque and the torque encountered by the steering wheel.

Example 9 includes the method of any preceding example, further including converting the torque encountered by the steering wheel to an associated force for the road wheel actuator, combining the overlay force and the associated force to obtain a combined force for the road wheel actuator, converting the combined force to a total torque for the steering wheel, and subtracting the torque encountered by the steering wheel from the total torque to obtain the overlay torque.

Example 10 includes the method of any preceding example, further including determining a feedback counter torque to be provided to the steering wheel based on a force applied by the road wheel actuator, and determining an output torque for the steering wheel actuator based on the feedback counter torque and the overlay torque.

Example 11 includes the method of any preceding example, further including utilizing a same conversion function or table to convert (i) the force applied by the road wheel actuator to the feedback counter torque and (ii) the combined force to the total torque for the steering wheel.

Example 12 includes the method of any preceding example, further including receiving a request to cause the road wheel actuator to apply the overlay force.

Example 13 includes the method of any preceding example, wherein the overlay force is proportional to a steering force applied to move steerable wheels of the vehicle.

Example 14 includes the method of any preceding example, wherein the overlay torque produces a movement of the steering wheel that results in an equilibrium between the overlay torque, the torque encountered by the steering wheel, and a feedback counter torque.

Example 15 includes an apparatus comprising interface circuitry, machine readable instructions, and programmable circuitry to at least one of instantiate or execute the machine readable instructions to identify an overlay force to be applied by a road wheel actuator of a vehicle, the overlay force from a driver assistance function, identify a torque encountered by a steering wheel, determine a steering wheel torque that corresponds with the overlay force and the torque encountered by the steering wheel, and determine an overlay torque for a steering wheel actuator based on the steering wheel torque and the torque encountered by the steering wheel.

Example 16 includes the apparatus of any preceding example, wherein the programmable circuitry is to at least one of instantiate or execute the machine readable instructions to determine a feedback counter torque to be provided to the steering wheel based on a force applied by the road wheel actuator, and determine an output torque for the steering wheel actuator based on the feedback counter torque and the overlay torque.

Example 17 includes the apparatus of any preceding example, wherein the programmable circuitry is to at least one of instantiate or execute the machine readable instructions to convert the torque encountered by the steering wheel to an associated force for the road wheel actuator, combine the overlay force and the associated force to obtain a combined force for the road wheel actuator, convert the combined force to a total torque for the steering wheel, and subtract the torque encountered by the steering wheel from the total torque to obtain the overlay torque.

Example 18 includes the apparatus of any preceding example, wherein the programmable circuitry is to at least one of instantiate or execute the machine readable instructions to determine a feedback counter torque to be provided to the steering wheel based on a force applied by the road wheel actuator, and wherein a same conversion function or table is utilized to convert (i) the force applied by the road wheel actuator to the feedback counter torque and (ii) the combined force to the total torque for the steering wheel.

Example 19 includes the apparatus of any preceding example, wherein the programmable circuitry is to receive a request to cause the road wheel actuator to apply the overlay force.

Example 20 includes the apparatus of any preceding example, wherein the overlay force is proportional to a steering force applied to move steerable wheels of the vehicle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A steer-by-wire steering system for a vehicle, the steer-by-wire steering system comprising:
a steering wheel actuator operatively coupled to a steering wheel;
a road wheel actuator operatively coupled to steerable wheels of the vehicle; and
programmable circuitry to communicate with the steering wheel actuator and the road wheel actuator, the programmable circuitry to at least one of instantiate or execute machine readable instructions to:
identify an overlay force to be applied by the road wheel actuator, the overlay force from a driver assistance function;
identify a torque encountered by the steering wheel;
determine a steering wheel torque that corresponds with the overlay force and the torque encountered by the steering wheel; and
determine an overlay torque for the steering wheel actuator based on the steering wheel torque and the torque encountered by the steering wheel.

2. The steer-by-wire steering system of claim 1, wherein the programmable circuitry is to at least one of instantiate or execute the machine readable instructions to:
determine a feedback counter torque to be provided to the steering wheel based on a force applied by the road wheel actuator; and
determine an output torque for the steering wheel actuator based on the feedback counter torque and the overlay torque.

3. The steer-by-wire steering system of claim 1, wherein the programmable circuitry is to at least one of instantiate or execute the machine readable instructions to:
convert the torque encountered by the steering wheel to an associated force for the road wheel actuator;
combine the overlay force and the associated force to obtain a combined force for the road wheel actuator;
convert the combined force to a total torque for the steering wheel; and
subtract the torque encountered by the steering wheel from the total torque to obtain the overlay torque.

4. The steer-by-wire steering system of claim 3, wherein the programmable circuitry is to at least one of instantiate or execute the machine readable instructions to determine a feedback counter torque to be combined with the overlay torque based on a force applied by the road wheel actuator, and wherein a same conversion function or table is utilized to convert (i) the force applied by the road wheel actuator to the feedback counter torque and (ii) the combined force to the total torque for the steering wheel.

5. The steer-by-wire steering system of claim 1, wherein the programmable circuitry is to receive a request to cause the road wheel actuator to apply the overlay force.

6. The steer-by-wire steering system of claim 1, wherein the overlay force is proportional to a steering force applied to move the steerable wheels.

7. The steer-by-wire steering system of claim 1, wherein the overlay torque produces a movement of the steering wheel that results in an equilibrium between the overlay torque, the torque encountered by the steering wheel, and a feedback counter torque.

8. A method comprising:
identifying an overlay force to be applied by a road wheel actuator of a vehicle, the overlay force from a driver assistance function;
identifying a torque encountered by a steering wheel;
determining a steering wheel torque that corresponds with the overlay force and the torque encountered by the steering wheel; and
determining an overlay torque for a steering wheel actuator based on the steering wheel torque and the torque encountered by the steering wheel.

9. The method of claim 8, further including:
converting the torque encountered by the steering wheel to an associated force for the road wheel actuator;
combining the overlay force and the associated force to obtain a combined force for the road wheel actuator;
converting the combined force to a total torque for the steering wheel; and
subtracting the torque encountered by the steering wheel from the total torque to obtain the overlay torque.

10. The method of claim 9, further including:
determining a feedback counter torque to be provided to the steering wheel based on a force applied by the road wheel actuator; and
determining an output torque for the steering wheel actuator based on the feedback counter torque and the overlay torque.

11. The method of claim 10, further including utilizing a same conversion function or table to convert (i) the force applied by the road wheel actuator to the feedback counter torque and (ii) the combined force to the total torque for the steering wheel.

12. The method of claim 8, further including receiving a request to cause the road wheel actuator to apply the overlay force.

13. The method of claim 8, wherein the overlay force is proportional to a steering force applied to move steerable wheels of the vehicle.

14. The method of claim 8, wherein the overlay torque produces a movement of the steering wheel that results in an equilibrium between the overlay torque, the torque encountered by the steering wheel, and a feedback counter torque.

15. An apparatus comprising:
interface circuitry;
machine readable instructions; and
programmable circuitry to at least one of instantiate or execute the machine readable instructions to:
identify an overlay force to be applied by a road wheel actuator of a vehicle, the overlay force from a driver assistance function;
identify a torque encountered by a steering wheel;
determine a steering wheel torque that corresponds with the overlay force and the torque encountered by the steering wheel; and
determine an overlay torque for a steering wheel actuator based on the steering wheel torque and the torque encountered by the steering wheel.

16. The apparatus of claim 15, wherein the programmable circuitry is to at least one of instantiate or execute the machine readable instructions to:
determine a feedback counter torque to be provided to the steering wheel based on a force applied by the road wheel actuator; and
determine an output torque for the steering wheel actuator based on the feedback counter torque and the overlay torque.

17. The apparatus of claim 15, wherein the programmable circuitry is to at least one of instantiate or execute the machine readable instructions to:
convert the torque encountered by the steering wheel to an associated force for the road wheel actuator;
combine the overlay force and the associated force to obtain a combined force for the road wheel actuator;
convert the combined force to a total torque for the steering wheel; and
subtract the torque encountered by the steering wheel from the total torque to obtain the overlay torque.

18. The apparatus of claim 17, wherein the programmable circuitry is to at least one of instantiate or execute the machine readable instructions to determine a feedback counter torque to be provided to the steering wheel based on a force applied by the road wheel actuator, and wherein a same conversion function or table is utilized to convert (i) the force applied by the road wheel actuator to the feedback counter torque and (ii) the combined force to the total torque for the steering wheel.

19. The apparatus of claim 15, wherein the programmable circuitry is to receive a request to cause the road wheel actuator to apply the overlay force.

20. The apparatus of claim 15, wherein the overlay force is proportional to a steering force applied to move steerable wheels of the vehicle.
